(19) United States
(12) Patent Application Publication
(10) Pub. No.: US 2016/0096739 A1
(43) Pub. Date: Apr. 7, 2016

(54) Iron powder product with high specific surface area

(71) Applicant: InNova Powders, Inc., Lexington, MA (US)

(72) Inventor: Carla D. Di Luca, Lexington, MA (US)

(21) Appl. No.: 14/867,466

(22) Filed: Sep. 28, 2015

Related U.S. Application Data
(60) Provisional application No. 62/056,771, filed on Sep. 29, 2014.

(51) Int. Cl. C01G 49/06

(52) U.S. Cl. CPC C01G 49/06; C01P 2006/12; C01P 2004/61

(57) ABSTRACT

A porous iron powder consisting essentially of a reduced iron powder having a specific surface area above 3000 m2/kg. The reduced iron powder is ferric oxide in a hydrogen environment and mechanical fluid bed operating at barometric pressure. The hydrogen environment has a pH₂/pH₂O ratio above 2.3. The reduced iron powder is ferric oxide produced by roasting of a solution of ferrous chloride. The end-product particle size is between 1 and 45 microns and has an in-vitro dissolution rate of 100% in at most twenty minutes.

### CROSS-REFERENCE TO RELATED APPLICATIONS

Benefit is hereby claimed to U.S. Provisional Application Ser. No. 62/056771, filed Sep. 29, 2014, the contents of which are incorporated by reference.

### BACKGROUND

1. Field of the Invention

The present invention relates to a low cost iron powder for fortifying food and applications that requires high surface area.

2. Description of the Related Art

U.S. Pat. No. 7,407,526 B2 describes a procedure to produce iron powder for food additions using natural irons oxide or ferric oxide produced in the roasting process. The reduction is performed using H2 or H2 and carbon as reductants, and the process consists of grinding the raw material to a particle size below 55 microns and reduction on a fixed bed belt furnace in temperatures up to 1,000° C. The sintered cake obtained is grinded and sieved at the desired particle size. The properties obtained with the above process are a specific surface area of 560 m2/kg and a dissolution rate in hydrochloric acid of at most 40% in 30 minutes. It is worth noting that the process described in the U.S. Pat. No. 7,407,526 B2 shows that the 560 m2/kg surface area is the highest value reported therein.

U.S. Pat. No. 8,333,821 teaches that it is possible to reduce ferric oxide powder in a mechanical fluid bed using various reductants such as ammonia, carbon and hydrogen to produce metallic iron or intermediate oxidation product. This patent also shows that the particle size distribution will not be affected by the reduction process provided a low temperature is used for the reduction process. This low temperature can be achieved by also controlling the pressure at which the reduction takes place. This and other references teach specific surface areas approaching 1000 m2/kg.

There is a need then for an iron powder product having a higher specific surface area and resulting bioavailability. Bioavailability is the degree and rate at which a substance is absorbed into a living system or is made available at the site of biological or physiological activity. As a consequence of a high specific surface area, a product with this property is distinguishing in that it is a natural choice for the production of food additives, environmental remediation and catalysts.

### SUMMARY OF THE INVENTION

It is an objective of the instant invention to provide in the market a low cost iron powder with high specific surface area for applications such as food additives, environmental remediation and catalysts.

It is further an objective to produce the iron powder from a high purity natural ferric oxide or synthetic ferric oxide generated from the roasting process of the ferrous chloride solutions produced during the pickling operation of steel in hydrochloric acid.

Accordingly, the invention comprehends a porous iron powder consisting essentially of a reduced iron powder having a specific surface area above 3000 m2/kg. The reduced iron powder is ferric oxide in a hydrogen environment and mechanical fluid bed. operating at barometric pressure. The hydrogen environment has a pH₂/pH₂O ratio above 2.3. The reduced iron powder is ferric oxide produced by roasting of a solution of ferrous chloride. The end-product particle size is between 1 and 45 microns and has an in-vitro dissolution rate of 100% in at most twenty minutes.

### DETAILED DESCRIPTION OF THE PREFERRED EMBODIMENT

The invention describes a process for the production of iron powder with a specific surface area of greater than 3000 m2/kg, which is a material characteristic of the product. As a consequence of the high specific surface area, the product also has a high bioavailability measured with the “in vitro” bioavailability method used as standard in the industry. The iron powder dissolves 100% in twenty (20) minutes. These properties are distinguishing in that it results in the natural choice for the production of food additives, environmental remediation and catalysts. It is also noted that the cost of production is low when compared with other processes.

### Feedstock

The iron oxide powder raw material, or feedstock, used for the production of the instant porous iron powder is the high purity ferric oxide (Fe₂O₃) produced in the roasting process of waste pickle liquors generated in steel pickling lines. Alternatively, it is possible to use high purity natural hematite (Fe₂O₃), magnetite (Fe₃O₄) or various forms of FeO.

Ferric oxide can produced by roasting of a solution of ferrous chloride, using the Ruthner process, and milled at the final particle size distribution desired. To achieve the properties indicated above, the feedstock must be selected to satisfy the purity criteria and also milled to reduce the particle size of the same to 45 microns or less.

### Reductant

The preferred reductant selected to achieve the desired properties of the iron powder is Hydrogen gas, The flow rate of hydrogen is maintained at a rate that provides a pH₂/pH₂O ratio preferable above 2.5.

### Production Process

The reduction of the feedstock is performed in a mechanical fluid bed operating on conditions that guarantee the stability of the fluid bed under the reduction conditions. The use of a rotary reactor and fluid bed to perform a complete reduction process in one reactor is described by U.S. Pat. No. 8,333,821. U.S. Pat. No. 8,333,821 is incorporated herein by reference and teaches that is possible to reduce ferric oxide powder in a mechanical fluid bed using various reductants such as ammonia, carbon and hydrogen to produce metallic iron or intermediate oxidation product. This patent also shows that the particle size distribution will not be affected by the reduction process provided a low temperature is used for the reduction process. This low temperature can be achieved by also controlling the pressure at which the reduction takes place. To this effect a set of internal fins are arranged and the dynamic conditions of the process, such as process gas flow rate, operating temperature and sure are taken into account to maintain the stability of the fluid bed and prevent an excessive contact time between the particles of the iron oxide and iron.

The rotation pattern of the mechanical fluid bed is adjusted to the operating conditions. The rotation rate changes during the production run and is set preferably between 60 and 80 rpm, adjusting the rate and direction to the particular phase of the run. This rotation rate also depends on the design of the internal fins, the process gas flow rate, and the process temperature.

The temperature of the reactor is set preferably between 600 and 700° C., This temperature is defined as a function of the pH₂/pH₂O ratio and the process gas flow rate.

When the reduction is complete, the iron powder is then removed to a cooling chamber under hydrogen. When the temperature reaches 60° C., the iron powder is blanketed. with nitrogen with a small concentration of oxygen to passivate the iron powder and prevent further reaction with air. This passivation method is cited as an example and can be replaced by any other suitable passivation method.

Once the iron powder is at room temperature, it may classified to separate families of particle size for different applications.

The results outlined above were obtained at barometric pressure; however the production capacity of the reactor can be increased by increasing the pressure of the same. The pressure can be increased up to the mechanical limit of the reactor and associated components.

### Characterization of the Product

An important and critical feature of the resulting iron powder is its specific surface area. High specific surface area leads to higher surface activity which is a highly desirable property for applications such as food additives, environmental remediation and catalysts.

The iron powder produced by this process has a specific surface area greater than 3000 m2/kg and is porous. “Porous” as used herein relates to the measure of the specific surface area and thus does not need to separately calculated. For example, the instant iron powder has a specific surface area of 3,030 m2/kg and with the proper selection of raw material and process parameters can go as high as 6,000 m2/kg. This difference in specific surface is the reason for its high reactivity in an acid solution. When the feedstock of the reactor is ferric oxide produced in a roasting process, such as the Ruthner process, the specific surface area of the iron powder produced is higher than 3000 m2/kg. The specific surface area is measured with an instrument that is specific for that property. Here, the surface area was measured with a Micomeritics Surface Area Analyzer based on chemisorption.

It is also noted that the in vitro bioavailability test shows that the iron powder dissolves 100% in less than 20 minutes. “In vitro” dissolution rate means the rate of dissolution based on the test adopted by the industry that consists of dissolving the iron in a hydrochloric acid standard solution at a given temperature. This acid solution simulates the gastric liquids and the percent of dissolution measures the ability of the iron powder to be bioavailable for the body.

I claim:

1. A porous iron powder consisting essentially of a reduce iron powder having a specific surface area above 3000 m2/kg.

2. The porous iron powder of claim 1, wherein said reduced iron powder is ferric oxide in a hydrogen environment and mechanical fluid bed operating at barometric pressure.

3. The porous iron powder of claim 2, wherein said hydrogen environment has a pH2/pH2O ratio above 2.3.

4. The porous iron powder of claim 1, wherein said reduced iron powder is ferric oxide produced by roasting of a solution of ferrous chloride.

5. The porous iron powder of claim 1, wherein a particle size is between 1 and 45 microns.

6. A porous iron powder consisting essentially of a reduced iron powder having an in-vitro dissolution rate of 100% in at most twenty minutes.

7. The porous iron powder of claim 6, wherein said reduced iron powder is ferric oxide in a hydrogen environment and mechanical fluid bed operating at barometric pressure.

8. The porous iron powder of claim 7, wherein said hydrogen environment has a pH2/pH2O ratio above 2.3.

9. The porous iron powder of claim 6, wherein said reduced iron powder is ferric oxide produced by roasting of a solution of ferrous chloride.

10. The porous iron powder of claim 6, wherein a particle size is between 1 and 45 microns.
